(19) United States
(12) Patent Application Publication
(10) Pub. No.: US 2009/0013663 A1
(43) Pub. Date: Jan. 15, 2009

(54) METHANE ENGINE FOR ROCKET PROPULSION

(75) Inventor: Kyoung Ho Kim, Gyeonggi-do (KR)

Correspondence Address: DANIEL B. SCHEIN, PH.D., ESQ., INC., P. O. BOX 68128, Virginia Beach, VA, 23471, US

(73) Assignee: C & Space Inc., Gyeonggi-do (KR)

(21) Appl. No.: 12/162,378

(22) PCT Filed: Mar. 7, 2007
(86) PCT No.: PCT/KR07/01121

§ 371 Date: Jul. 28, 2008

(30) Foreign Application Priority Data
Jul. 7, 2006 (KR) 10-2006-0064106

(51) Int. Cl. F02K 9/48

(52) U.S. Cl. 60/39.461; 60/266; 60/770

(57) ABSTRACT

Disclosed is a methane engine for rocket propulsion. A methane supply pump (36) operated by a turbine (30) supplies a part of methane to a nozzle cooling channel (56, 156) installed on a nozzle (54, 154) of a combustor (50, 150) and supplies the other part of the methane to a combustion chamber cooling channel (53, 153) installed on a combustion chamber (52, 152) of the combustor (50, 150) so as to regulate the amount of methane supplied to a mixing head (51, 151) while maintaining the cooling properties of the combustor (50, 150), thus providing extensity of coping with changes in propulsive force and design of the combustor (50, 150). Further, a part of methane in a gas state discharged from the combustion chamber cooling channel (53, 153) is supplied to a mixing head (76) of a gas generator (94), thus providing the re-liability of the engine.

### TECHNICAL FIELD

The present invention relates to an engine for rocket propulsion, and more particularly to a methane engine for rocket propulsion, in which a methane supply pump operated by a turbine supplies a part of methane to a nozzle cooling channel installed on a nozzle of a combustor and supplies the other part of the methane to a combustion chamber cooling channel installed on a combustion chamber of the combustor so as to regulate the amount of methane supplied to a mixing head of the combustor while maintaining the cooling properties of the combustor to provide extensity of coping with changes in propulsive force and design of the combustor, and a part of methane in a gas state discharged from the combustion chamber cooling channel is supplied to a mixing head of a gas generator so as to provide reliability.

### BACKGROUND ART

Generally, engines for rocket propulsion are propelling apparatuses, which launch a rocket, a missile, or a space shuttle into the atmosphere by propulsive force caused due to a hot gas jetted from a combustor by igniting a fuel and an oxidizer respectively supplied from a fuel pump and an oxidizer pump, which are rotated by driving a turbine using a gas generated from a gas generator, to the combustor.

Conventionally, kerosene or hydrogen was mainly used as a fuel for rocket propulsion. Kerosene is comparatively stable at normal temperature, but is not excellent in terms of regenerative cooling properties, which effectively cools a combustor. Hydrogen is not stable at normal temperature, and thus requires a high pressure airtight tank for safekeeping, thereby having a limit of material compatibility.

When a combustion chamber and a nozzle (referred to also as “a thrust chamber”) of the combustor are not properly cooled, melt fracture of the inner walls of the combustion chamber and the nozzle occurs due to heat (approximately 3,500K) and pressure (approximately 80 atm) generated from the combustion chamber. In order to prevent the above melt fracture, a thermal barrier coating (TBC) method or a film coating (FC) method was used to isolate the inner walls of the combustion chamber and the nozzle from the heat, or a regenerative cooling method, in which a propellent fuel is supplied to the combustion chamber and the nozzle so as to cool the combustion chamber and the nozzle, was used.

However, the TBC method is not proper in terms of regeneration, and the FC method is not advantageous in terms of efficiency.

Hereinafter, the regenerative cooling method, in which a propellent fuel is supplied to a combustion chamber and a nozzle, will be described.

FIG. 1 is a schematic view of a conventional engine for rocket propulsion using kerosene or hydrogen.

The conventional engine includes a gas generator 14 mixing a fuel, such as kerosene or hydrogen, supplied from a fuel branch supply pipe 10 and an oxidizer, such as oxygen, supplied from an oxidizer branch supply pipe 21, and igniting and jetting the fuel gas, a turbine 2 generating driving force using the gas generated from the gas generator 14, a fuel supply pump 4 coaxially fixed to the turbine 2 for supplying the fuel stored in a fuel tank, an oxidizer supply pump 18 coaxially fixed to the turbine 2 for supplying the oxidizer stored in an oxidizer tank, and a combustor 26 receiving the fuel and oxidizer supplied from the fuel supply pump 4 and the oxidizer supply pump 18 through a fuel supply pipe 6 and an oxidizer supply pipe 20 and igniting and jetting the fuel gas to provide propulsive force to a projectile, such as a rocket, a missile, or a space shuttle.

Before the fuel and the oxidizer are supplied to the gas generator 14, the optimum supply amounts of the fuel and the oxidizer are regulated by control valves 12 and 13 respectively installed in the fuel branch supply pipe 10 and the oxidizer branch supply pipe 21.

Further, before the fuel and the oxidizer are supplied to the combustor 26, the optimum ratio of the fuel and the oxidizer is regulated by a fuel control valve 8 and an oxidizer control valve 22 respectively installed in the fuels supply pipe 6 and the oxidizer supply pipe 20, and then the fuel and the oxidizer are supplied to a mixing head (not shown) installed at an inlet of the combustor 26 so as to generate the optimum propulsive force.

While the fuel in a low-temperature state, such as kerosene or hydrogen, supplied from the fuel supply pipe 6 passes through an external cooling channel 24 from a nozzle part at the end of the combustor 26, the fuel absorbs a part of heat of a high temperature generated from the combustor 26, and thus performs the cooling of the combustor 26 under the condition that the enthalpy (total potential energy) of the fuel increases. Then, the fuel in a nearly gas state is supplied to the mixing head of the combustor 26, and thus generates propulsive force. This cooling method is referred to as a regenerative cooling method.

The conventional engine for rocket propulsion using kerosene or hydrogen as a fuel has several problems below.

First, in case that kerosene is used as a fuel for rocket propulsion, kerosene is comparatively stable at normal temperature, but is not excellent in terms of regenerative cooling properties.

Second, in case that hydrogen is used as a fuel for rocket propulsion, hydrogen is not stable at normal temperature, and thus requires a high pressure airtight tank withstanding a high pressure for safekeeping. Further, hydrogen has a limit of material compatibility.

Third, since a fuel supplied from the fuel supply pump 4 integrally cools the cooling channel 24 installed on the whole portions of the combustion chamber and the nozzle of the combustor 26, extensity in design of the combustor 26 coping with changes of propulsive force and design of the combustor 26 is not assured. Thus, the engine has a limit in design.

Fourth, a fuel in a liquid state through the fuel branch supply pipe 10 and an oxidizer in a liquid state the oxidizer branch supply pipe 21 are supplied to the mixing head of the gas generator 14, and a fuel in a nearly gas state, the enthalpy of which increases by passing through the cooling channel 24, and an oxidizer in a liquid state through the oxidizer supply pipe 20 are supplied to the mixing head of the combustor 26. That is, since the fuels of different phases are supplied to the mixing head of the gas generator 14 and the mixing head of the combustor 26, the mixing heads use separate injectors requiring different phases. Thus, the compatibility of the injectors is limited, the reliability of the engine is lowered, and the number of components of the engine and the production costs of the engine are increased.

Fifth, after used in the combustor 26, kerosene leaves combustion waste in main components of the engine, such as the turbine 2, thus not providing the reliability and the repeatability of the engine. Thereby, the engine cannot be reusable.

### DISCLOSURE OF INVENTION

### Technical Problem

Therefore, the present invention has been made in view of the above problems, and it is an object of the present invention to provide a methane engine for rocket propulsion, in which a methane supply pump operated by a turbine supplies a part of methane to a nozzle cooling channel installed on a nozzle of a combustor and supplies the other part of the methane to a combustion chamber cooling channel installed on a combustion chamber of the combustor so as to regulate the amount of methane supplied to a mixing head of the combustor while maintaining the cooling properties of the combustor to provide extensity of coping with changes in propulsive force and design of the combustor, and a part of methane in a gas state discharged from the combustion chamber cooling channel is supplied to a mixing head of a gas generator so as to provide reliability.

Technical Solution

In accordance with an aspect of the present invention, the above and other objects can be accomplished by the provision of a methane engine for rocket propulsion, comprising a gas generator mixing methane supplied from a methane gas supply pipe and an oxidizer supplied from an oxidizer branch supply pipe, and igniting and jetting the methane gas; a turbine generating driving force using a hot gas generated from the gas generator; a methane supply pump coaxially fixed to the turbine for supplying methane in a liquid state stored in a methane storage tank to a methane supply pipe; an oxidizer supply pump coaxially fixed to the turbine for supplying the oxidizer stored in an oxidizer storage tank to an oxidizer supply pipe; and a combustor receiving the methane and the oxidizer supplied from the methane supply pump and the oxidizer supply pump through the methane supply pipe and the oxidizer supply pipe, and igniting and jetting the methane gas to provide propulsive force to a projectile, selected from the group consisting of a rocket, a missile, and a space shuttle, wherein the methane supply pipe is branched into a nozzle supply pipe and a combustion chamber supply pipe, the nozzle supply pipe supplies the methane to a nozzle cooling channel installed on the outer surface of a nozzle of the combustor so that the methane is discharged to a nozzle transfer pipe to perform the regenerative cooling of the nozzle, and the combustion chamber supply pipe supplies the methane to a combustion chamber cooling channel installed on the outer surface of a combustion chamber of the combustor so that the methane is discharged to a combustion chamber transfer pipe to perform the regenerative cooling of the combustion chamber, so that the regenerative cooling of the nozzle and the regenerative cooling of the combustion chamber are independently performed.

Preferably, multiple methane control valves for regulating the pressure and the flow rate of the methane supplied from the methane supply pump to a mixing head of the combustor are installed in the methane supply pipe.

Preferably, multiple oxidizer control valves for regulating the pressure and the flow rate of the oxidizer supplied from the oxidizer supply pump to a mixing head of the combustor are installed in the oxidizer supply pipe.

Preferably, the nozzle cooling channel is connected to the nozzle supply pipe, is installed on the outer surface of the nozzle from the central portion of the combustor to the discharge end of the nozzle, and comes out into the nozzle transfer pipe; the combustion chamber cooling channel is connected to the combustion chamber supply pipe, is installed on the outer surface of the combustion chamber from the central portion of the combustor to the inlet of the combustion chamber, and comes out into the combustion chamber transfer pipe; and the nozzle transfer pipe and the combustion chamber transfer pipe are joined together into a main supply pipe, and supply a fluid in a gas state to a mixing head of the combustor.

Preferably, the nozzle cooling channel and the combustion chamber cooling channel are obtained by winding a pipe having a circular, oval, or polygonal section on the outer surfaces of the nozzle and the combustion chamber in a spiral shape.

More preferably, the outer surfaces of the nozzle cooling channel and the combustion chamber cooling channel are coated with a cooling channel cover for protecting the nozzle cooling channel and the combustion chamber cooling channel.

Further, preferably, the nozzle cooling channel and the combustion chamber cooling channel are obtained by forming grooves in the outer surfaces of the nozzle and the combustion chamber and coating the outer surfaces of the nozzle and the combustion chamber with a cooling channel cover, so that the methane can be transferred through the nozzle cooling channel and the combustion chamber cooling channel.

Preferably, a nozzle inlet control valve is installed in the nozzle supply pipe at the inlet of the nozzle cooling channel and a nozzle outlet control valve is installed in the nozzle transfer pipe at the outlet of the nozzle cooling channel, and a control unit controls the nozzle inlet and outlet control valves in an interlocked state to effectively regulate the flow rate and the pressure of the methane transferred through the nozzle cooling channel so that the design of the nozzle of the combustor can be easily changed.

Preferably, a combustion chamber inlet control valve is installed in the combustion chamber supply pipe at the inlet of the combustion chamber cooling channel and a combustion chamber outlet control valve is installed in the combustion chamber transfer pipe at the outlet of the combustion chamber cooling channel, and a control unit controls the combustion chamber inlet and outlet control valves in an interlocked state to effectively regulate the flow rate and the pressure of the methane transferred through the combustion chamber cooling channel so that the design of the combustion chamber of the combustor can be easily changed.

Preferably, a methane gas supply pipe is branched off from the combustion chamber transfer pipe, and methane in a gas state, the enthalpy of which has increased by absorbing heat energy from the combustion chamber, is supplied to a mixing head of the gas generator through the methane gas supply pipe.

Preferably, a check valve for preventing the backward flow of the methane gas is installed in the methane gas supply pipe.

Preferably, multiple control valves for regulating the pressure and the flow rate of the methane gas before the methane gas is supplied to the mixing head of the gas generator are installed in the methane gas supply pipe.

Preferably, a check valve for preventing the backward flow of the oxidizer and multiple control valves for regulating the pressure and the flow rate of the oxidizer supplied to a mixing head of the gas generator are installed in the oxidizer branch supply pipe.

Preferably, If the purity of methane fuel should be greater than 90%, any kind of fuel can be used for methane engine. Therefore Liquefied Natural Gas (LNG) may be considered to be methane fuel if the proportion of methane is greater than 90%.

### Advantageous Effects

The methane engine for rocket propulsion of the present invention has several advantages, as described below.

First, a methane supply pump operated by a turbine supplies a part of methane to a nozzle cooling channel installed on a nozzle of a combustor, and supplies the other part of the methane to a combustion chamber cooling channel installed on a combustion chamber of the combustor, so as to regulate the amount of methane supplied to a mixing head of the combustor while maintaining the cooling properties of the combustor, thus providing extensity of coping with changes in propulsive force and design of the combustor.

Second, since a part of methane in a gas state discharged from the combustion chamber cooling channel is supplied to a mixing head of a gas generator, the same injector is used in the mixing heads of the gas generator and the combustor, thus increasing compatibility of components to reduce the number of the components of the engine, and providing reliability of the engine.

Third, compared with kerosene used as a conventional fuel, methane used as a fuel is excellent in terms of regenerative cooling properties, thus effectively cooling the combustor.

Fourth, compared with hydrogen used as a conventional fuel, methane used as a fuel is stable at normal temperature, and does not require a high pressure airtight tank withstanding a high pressure for safekeeping.

Fifth, after used in the combustor, methane, which has excellent environmental friendliness, is completely burned, thus not leaving waste in main components of the engine, such as a turbine. Therefore, the engine is reusable, and provides reliability and repeatability

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic view of a conventional engine for rocket propulsion using kerosene or hydrogen;

FIG. 2 is a schematic view of a methane engine for rocket propulsion in accordance with the present invention;

FIG. 3 is a detailed view illustrating a gas generator and a turbine of the methane engine for rocket propulsion of the present invention;

FIG. 4 is a detailed view illustrating a combustor of a methane engine for rocket propulsion in accordance with one embodiment of the present invention;

FIG. 5 is a detailed view illustrating a combustor of a methane engine for rocket propulsion in accordance with another embodiment of the present invention; and

FIG. 6 is a schematic view of the methane engine for rocket propulsion of the present invention in a used state.

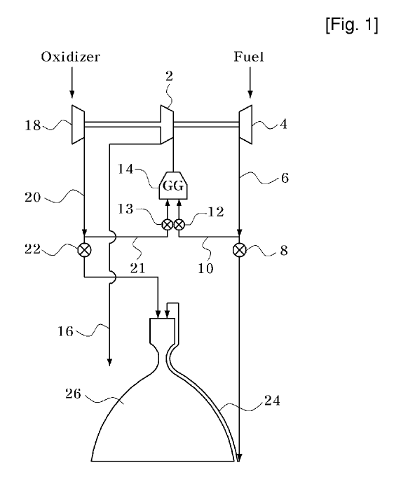

### MODE FOR THE INVENTION

Now, preferred embodiments of the present invention will be described in detail with reference to the annexed drawings.

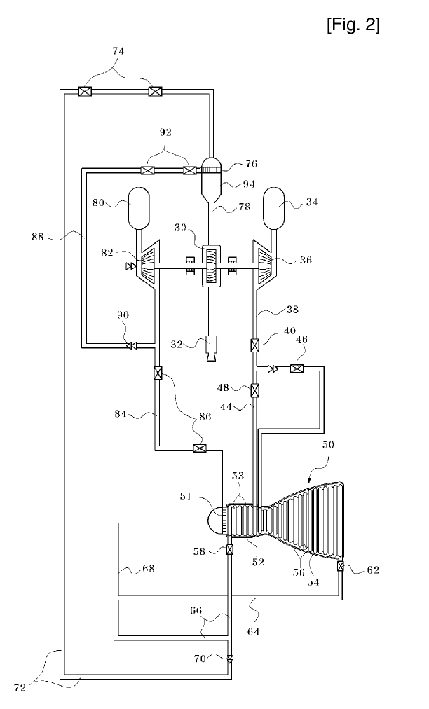

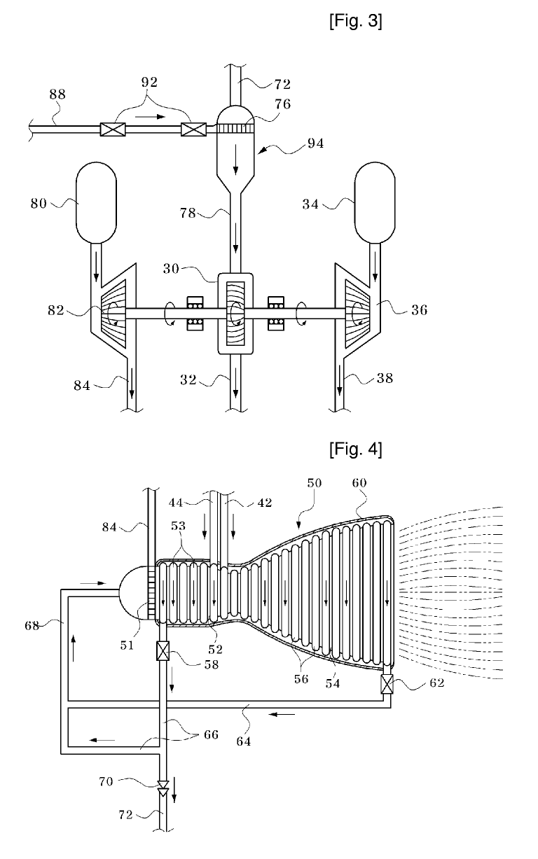

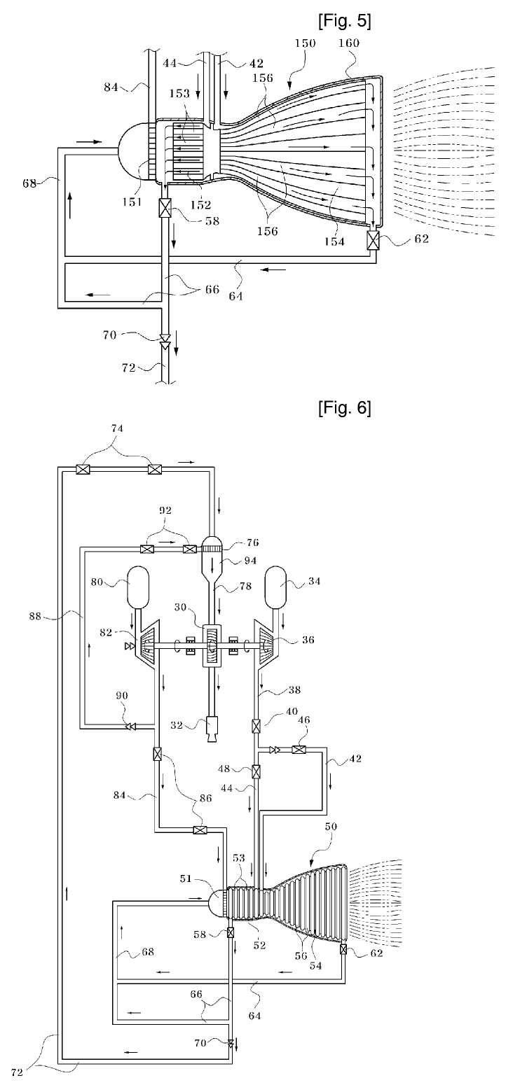

FIG. 2 is a schematic view of a methane engine for rocket propulsion in accordance with the present invention, FIG. 3 is a detailed view illustrating a gas generator and a turbine of the methane engine of the present invention, FIG. 4 is a detailed view illustrating a combustor of a methane engine for rocket propulsion in accordance with one embodiment of the present invention, FIG. 5 is a detailed view illustrating a combustor of a methane engine for rocket propulsion in accordance with another embodiment of the present invention, and FIG. 6 is a schematic view of the methane engine of the present invention in a used state.

A methane engine for rocket propulsion in accordance with the present invention includes a gas generator 94 mixing methane, used as a fuel, supplied from a methane gas supply pipe 72 and an oxidizer, i.e., oxygen, supplied from an oxidizer branch supply pipe 88, and igniting and jetting the methane gas, a turbine 30 generating driving force using a hot gas generated from the gas generator 94, a methane supply pump 36 coaxially fixed to the turbine 30 for supplying methane in a liquid state stored in a methane storage tank 34 to a methane supply pipe 38, an oxidizer supply pump 82 coaxially fixed to the turbine 30 for supplying the oxidizer stored in an oxidizer storage tank 80 to an oxidizer supply pipe 84, and a combustor 50 or 150 receiving the methane and the oxidizer supplied from the methane supply pump 36 and the oxidizer supply pump 83 through the methane supply pipe 38 and the oxidizer supply pipe 84 and igniting and hot gas a methane gas to provide propulsive force to a projectile, such as a rocket, a missile, or a space shuttle.

multiple methane control valves 40 for regulating the pressure and the flow rate of the methane supplied from the methane supply pump 36 to a mixing head 51 or 151 of the combustor 50 or 150 are installed in the methane supply pipe 38.

Further, multiple oxidizer control valves 86 for regulating the pressure and the flow rate of the oxidizer supplied from the oxidizer supply pump 82 to the mixing head 51 or 151 of the combustor 50 or 150 are installed in the oxidizer supply pipe 84.

The methane supply pipe 38 connecting the methane supply pump 36 and the combustor 50 or 150 is branched into a nozzle supply pipe 42 and a combustion chamber supply pipe 44.

The nozzle supply pipe 42 supplies methane to a nozzle cooling channel 56 or 156 installed on the outer surface of a nozzle 54 or 154 of the combustor 50 or 150, so that the methane is discharged to a nozzle transfer pipe 64, thereby performing the regenerative cooling of the nozzle 54 or 154.

The combustion chamber supply pipe 44 supplies methane to a combustion chamber cooling channel 53 or 153 installed on the outer surface of a combustion chamber 52 or 152 of the combustor 50 or 150, so that the methane is discharged to a combustion chamber transfer pipe 66, thereby performing the regenerative cooling of the combustion chamber 52 or 152. Therefore, it is possible to perform the regenerative cooling of the nozzle 54 or 154 and the regenerative cooling of the combustion chamber 52 or 152, independently.

The nozzle cooling channel 56 or 156 is connected to the nozzle supply pipe 42, is installed on the outer surface of the nozzle 54 or 154 from the central portion of the combustor 50 or 150 to the discharge end of the nozzle 54 or 154, and comes out into the nozzle transfer pipe 64.

The combustion chamber cooling channel 53 or 153 is connected to the combustion chamber supply pipe 44 is installed on the outer surface of the combustion chamber 52 or 152 from the central portion of the combustor 50 or 150 to the inlet of the combustion chamber 52 or 152, and comes out into the combustion chamber transfer pipe 66.

The nozzle transfer pipe 64 and the combustion chamber transfer pipe 66 are joined together into a main supply pipe 68, and supply a fluid in a gas state to the mixing head 51 of the combustor 50 or 150.

As shown in FIG. 4, preferably, the nozzle cooling channel 56 and the combustion chamber cooling channel 53 are obtained by winding a pipe having a circular, oval, or polygonal section on the outer surfaces of the nozzle 54 and the combustion chamber 52 in a spiral shape.

In order to protect the nozzle cooling channel 56 and the combustion chamber cooling channel 53, the outer surfaces of the nozzle cooling channel 56 and the combustion chamber cooling channel 53 are coated with a cooling channel cover 60.

As shown in FIG. 5, the nozzle cooling channel 156 and the combustion chamber cooling channel 153 are obtained by forming grooves having a designated depth in a lengthwise direction in the outer surfaces of the nozzle 154 and the combustion chamber 152, and coating the outer surfaces of the nozzle 154 and the combustion chamber 152 with a cooling channel cover 160 so that methane can be transferred therethrough.

Instead of forming the grooves in a lengthwise direction, as shown in FIG. 5, the nozzle cooling channel 156 and the combustion chamber cooling channel 153 may be obtained by winding a pipe in a spiral shape on the surfaces of the nozzle 154 and the combustion chamber 152 or by various methods.

A nozzle inlet control valve 46 is installed in the nozzle supply pipe 42 at the inlet of the nozzle cooling channel 56 or 156, and a nozzle outlet control valve 62 is installed in the nozzle transfer pipe 64 at the outlet of the nozzle cooling channel 56 or 156. The nozzle inlet control valve 46 and the nozzle outlet control valve 62 are controlled in an interlocked state, and effectively regulate the pressure and the flow rate of the methane transferred through the nozzle cooling channel 56 or 156, thereby facilitating design changes of the nozzle 54 or 154 of the combustor 50 or 150, i.e., changes in propulsive force and shape of the nozzle 54 or 154, and thus providing extensity.

A combustion chamber inlet control valve 48 is installed in the combustion chamber supply pipe 44 at the inlet of the combustion chamber cooling channel 53 or 153, and a combustion chamber outlet control valve 58 is installed in the combustion chamber transfer pipe 66 at the outlet of the 7 combustion chamber cooling channel 53. The combustion chamber inlet control valve 48 and the combustion chamber outlet control valve 58 are controlled in an interlocked state, and effectively regulate the pressure and the flow rate of the methane transferred through the combustion chamber cooling channel 53 or 153, thereby facilitating design changes of the combustion chamber 52 or 152 of the combustor 50 or 150, i.e., changes in propulsive force and shape of the combustion chamber 52 or 152, and thus providing extensity.

A methane gas supply pipe 72 is branched off from the combustion chamber transfer pipe 66, and supplies methane in a gas state, the enthalpy which has increased by absorbing of heat energy from the combustion chamber 52 or 152, to a mixing head 76 of the gas generator 94.

A check valve 70 for preventing the backward flow of the methane gas is installed in the methane gas supply pipe 72.

multiple control valves 74 for regulating the pressure and the flow rate of the methane gas before the methane gas is supplied to the mixing head 76 of the gas generator 94 are installed in the methane gas supply pipe 72.

A check valve for preventing the backward flow of the oxidizer and multiple control valves 92 for regulating the pressure and the flow rate of the oxidizer supplied to the mixing head 76 of the gas generator 94 are installed in the oxidizer branch supply pipe 88.

Hereinafter, the function and effects of the present invention will be described with reference to the annexed drawings.

First, with reference to FIGS. 3 and 6, the operating state of the methane engine for rocket propulsion of the present invention will be described. Methane in a gas state supplied from the methane gas supply pipe 72 and an oxidizer in a liquid state supplied from the oxidizer branch supply pipe 88 are supplied to the mixing head 76 of the gas generator 94, and are ignited with a spark plug (not shown), thus generating a hot gas. Then, the turbine 30 is driven by the hot gas.

multiple the control valves 74 and 92 for reducing the pressures of the methane and the oxidizer or regulating the flow rates of the methane and the oxidizer are respectively installed in the methane gas supply pipe 72 and the oxidizer branch supply pipe 88 at the inlet of the mixing head 76 of the gas generator 94.

When the turbine 30 is driven, the methane supply pump 36 integrally fixed to a rotary shaft of the turbine 30 is operated, pumps out methane in a liquid state stored in the methane storage tank 34, and supplies the methane to the methane supply pipe 38.

Further, the oxidizer supply pump 82 integrally fixed to the rotary shaft of the turbine 30 is operated, pumps out an oxidizer solution stored in the oxidizer storage tank 80, and supplies the oxidizer solution to the oxidizer supply pipe 84.

The methane control valve 40 is installed in the methane supply pipe 38 so as to regulate the pressure and the flow rate of the flowing methane.

The methane supply pipe 38 is branched into two sub-pipes, i.e., the nozzle supply pipe 42 and the combustion chamber supply pipe 44 so that the nozzle supply pipe 42 and the combustion chamber supply pipe 44 respectively enter the nozzle 54 and the combustion chamber 52 at the boundary therebetween at the central portion of the combustor 50.

Here, as shown in FIG. 4, the nozzle supply pipe 42 is connected to the nozzle cooling channel 56, and the nozzle cooling channel 56 is obtained by winding a pipe on the outer surface of the nozzle 54 of the combustor 50 in a spiral shape and is connected to the nozzle transfer pipe 64 at the outer part of the end of the nozzle 54.

Further, the combustion chamber supply pipe 44 is connected to the combustion chamber cooling channel 53, and the combustion chamber cooling channel 53 is obtained by winding a pipe on the outer surface of the combustion chamber 32 of the combustor 50 in a spiral shape and is connected to the combustion chamber transfer pipe 66 at the outer part of the inlet of the combustion chamber 52, i.e., at the front end of the mixing head 51.

Preferably, the nozzle cooling channel 56 and the combustion chamber cooling channel 53 has a pipe shape having a circular, oval, or polygonal section. Methane in a liquid state absorbs heat of a high temperature generated from the combustion chamber 52 and the nozzle 54 of the combustor 50, which is raised to a temperature of 3,500K and a pressure of 80 atm, and thus achieves the regenerative cooling of the combustor 50, thereby preventing the melt fracture of the combustor 50 due to overheating.

The cooling channel cover 60 for protecting the nozzle cooling channel 56 and the combustion chamber cooling channel 53 is coated on the outer surfaces of the nozzle cooling channel 56 and the combustion chamber cooling channel 53.

The nozzle inlet control valve 46 and the nozzle outlet control valve 62 are respectively installed in the nozzle supply pipe 42 at the inlet of the nozzle cooling channel 56 and the nozzle transfer pipe 64 at the outlet of the nozzle cooling channel 56, and thus effectively regulate the transfer amount and the pressure of the methane flowing through the nozzle 54 of the combustor 50.

Further, the combustion chamber inlet control valve 48 and the combustion chamber outlet control valve 58 are respectively installed in the combustion chamber supply pipe 44 at the inlet of the combustion chamber cooling channel 53 and the combustion chamber transfer pipe 66 at the outlet of the combustion chamber cooling channel 53, and effectively regulate the transfer amount and the pressure of the methane flowing through the combustion chamber 52 of the combustor 50.

The transfer amounts and the pressures of methane, which are required by the nozzle 54 and the combustion chamber 52, can be respectively regulated by allowing a control unit to control the flow rates of methane in the nozzle cooling channel 56 and the combustion chamber cooling channel 53 using the four control valves 46, 48, 58, and 62. Therefore, the nozzle 54 and the combustion chamber 52 of the combustor 50 can be changed in design according to propulsive forces and shapes of the nozzle 54 and the combustion chamber 52, thus providing extensity in design.

FIG. 5 illustrates the combustor 150 of the methane engine in accordance with another embodiment. As shown in FIG. 5, the nozzle cooling channel 156 and the combustion chamber cooling channel 153 are obtained by forming grooves having a designated depth in a lengthwise direction in the outer surfaces of the nozzle 154 and the combustion chamber 152, and coating the outer surfaces of the nozzle 154 and the combustion chamber 152 with the cooling channel cover 160. Thereby, methane flows through the nozzle cooling channel 156 and the combustion chamber cooling channel 153, thus performing the regenerative cooling of the nozzle cooling channel 156 and the regenerative cooling of the combustion chamber cooling channel 153.

Instead of forming the grooves in a lengthwise direction, as shown in FIG. 5, the nozzle cooling channel 156 and the combustion chamber cooling channel 153 may be obtained by winding a pipe in a spiral shape on the surfaces of the nozzle 154 and the combustion chamber 152 or by various methods.

As shown in FIG. 4 and FIG. 5, Methane, which flows through the nozzle cooling channel 56 or 156 and the combustion chamber cooling channel 53 or 153 to perform the regenerative cooling of the nozzle cooling channel 156 and the regenerative cooling of the combustion chamber cooling channel 153, is the main component of a liquefied natural gas (LNG). Methane, which has environmental friendliness and is reusable, has a higher thermal capacity than that of liquid oxygen used as an oxidizer or other hydrocarbon-based fuels, thus being advantageous in cooling. Further, methane provides a sufficient cooling effect through regenerative cooling without using a separate wall cooling apparatus.

If the purity of methane should be greater than 90%, any kind of fuel can be used for methane engine. Therefore Liquefied Natural Gas (LNG) may be considered to be methane fuel if the proportion of methane is greater than 90%.

While methane, to be transferred to the nozzle transfer pipe 64 and the combustion chamber transfer pipe 66, passes through the nozzle 54 or 154 and the combustion chamber 52 or 152 of the combustor 50 or 150, the methane has an increased enthalpy by absorbing heat energy from the nozzle 54 or 154 and the combustion chamber 52 or 154. Thereby, methane in a high-pressure fluid state nearly close to a gas state is transferred to the nozzle transfer pipe 64 and the combustion chamber transfer pipe 66, and further to the main supply pipe 68, into which the nozzle transfer pipe 64 and the combustion chamber transfer pipe 66 are joined together.

The above methane together with the oxidizer supplied through the oxidizer supply pipe 84 comes into the mixing head 51 or 151, is jetted by an injector of the mixing head 51 or 151, is ignited with the spark plug, and is burned in the combustion chamber 52 or 152. Then, the nozzle 54 or 154 jets a hot gas, and thus generates propulsive force for launching a projectile, such as a rocket, a missile, or a space shuttle.

multiple the oxidizer control valves 86 are installed in the oxidizer supply pipe 84, and regulates the amount of the oxidizer coming into the mixing head 51 or 151. In case that oxygen in the outer part of the atmosphere is insufficient, when the combustor 50 or 150 is operated, the oxidizer supplies the sufficient amount of oxygen to the combustor 50 or 150.

A part of the oxidizer is supplied to the oxidizer branch supply pipe 88 branched off from the oxidizer supply pipe 84, and the check valve 90 for preventing the backward flow of the oxidizer is installed in the oxidizer branch supply pipe 88.

Methane is supplied to the mixing head 76 of the gas generator 94 through the methane gas supply pipe 72 branched off from the combustion chamber transfer pipe 66, and then the mixing head 76 jets methane in a high-pressure state close to a gas state. Thereby, the mixing head 76 of the gas generator 94 has a high hot gas efficiency, thus providing the reliability of the methane engine.

Although the present invention describes a methane engine for rocket propulsion, the methane engine may be comprehensively applied to a missile, a space shuttle, and other propelling apparatuses which require propulsive force.

### INDUSTRIAL APPLICABILITY

As apparent from the above description, the present invention provides a methane engine for rocket propulsion, which has several advantages, as described below.

First, a methane supply pump operated by a turbine supplies a part of methane to a nozzle cooling channel installed on a nozzle of a combustor, and supplies the other part of the methane to a combustion chamber cooling channel installed on a combustion chamber of the combustor, so as to regulate the amount of methane supplied to a mixing head of the combustor while maintaining the cooling properties of the combustor, thus providing extensity of coping with changes in propulsive force and design of the combustor.

Second, since a part of methane in a gas state discharged from the combustion chamber cooling channel is supplied to a mixing head of a gas generator, the same injector is used in the mixing heads of the gas generator and the combustor, thus increasing compatibility of components to reduce the number of the components of the engine, and providing the reliability of the engine.

Third, compared with kerosene used as a conventional fuel, methane used as a fuel is excellent in terms of regenerative cooling properties, thus effectively cooling the combustor.

Fourth, compared with hydrogen used as a conventional fuel, methane used as a fuel is stable at normal temperature, and does not require a high pressure airtight tank withstanding a high pressure for safekeeping.

Fifth, after used in the combustor, methane, which has excellent environmental friendliness, is completely burned, thus not leaving waste in main components of the engine, such as a turbine. Therefore, the engine is reusable, and provides reliability and repeatability.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A methane engine for rocket propulsion, comprising:
a gas generator mixing methane supplied from a methane gas supply pipe and an oxidizer supplied from an oxidizer branch supply pipe, and jetting and igniting the methane gas;
a turbine generating driving force using a methane gas flame generated from the gas generator;
a methane supply pump coaxially fixed to the turbine for supplying methane in a liquid state stored in a methane storage tank to a methane supply pipe;
an oxidizer supply pump coaxially fixed to the turbine for supplying the oxidizer stored in an oxidizer storage tank to an oxidizer supply pipe; and
a combustor receiving the methane and the oxidizer supplied from the methane supply pump and the oxidizer supply pump through the methane supply pipe and the oxidizer supply pipe, and igniting and jetting the methane gas to provide propulsive force to a projectile, selected from the group consisting of a rocket, a missile, and a space shuttle,
wherein the methane supply pipe is branched into a nozzle supply pipe and a combustion supply pipe, the nozzle supply pipe supplies the methane to a nozzle cooling channel installed on the outer surface of a nozzle of the combustor so that the methane is discharged to a nozzle transfer pipe to perform the regenerative cooling of the nozzle, and the combustion supply pipe supplies the methane to a combustion chamber cooling channel installed on the outer surface of a combustion chamber of the combustor so that the methane is discharged to a combustion chamber transfer pipe to perform the regenerative cooling of the combustion chamber, so that the regenerative cooling of the nozzle and the regenerative cooling of the combustion chamber are independently performed.

2. The methane engine according to claim 1, wherein a plurality of methane control valves for regulating the pressure and the flow rate of the methane supplied from the methane supply pump to a mixing head of the combustor are installed in the methane supply pipe.

3. The methane engine according to claim 1, wherein a plurality of oxidizer control valves for regulating the pressure and the flow rate of the oxidizer supplied from the oxidizer supply pump to a mixing head of the combustor are installed in the oxidizer supply pipe.

4. The methane engine according to claim 1, wherein:
the nozzle cooling channel is connected to the nozzle supply pipe, is installed on the outer surface of the nozzle from the central portion of the combustor to the discharge end of the nozzle, and comes out into the nozzle transfer pipe;
the combustion chamber cooling channel is connected to the combustion chamber supply pipe, is installed on the outer surface of the combustion chamber from the central portion of the combustor to the inlet of the combustion chamber, and comes out into the combustion chamber transfer pipe; and
the nozzle transfer pipe and the combustion chamber transfer pipe are joined together into a main supply pipe, and supply a fluid in a gas state to a mixing head of the combustor.

5. The methane engine according to claim 1, wherein the nozzle cooling channel and the combustion chamber cooling channel are obtained by winding a pipe having a circular, oval, or polygonal section on the outer surfaces of the nozzle and the combustion chamber in a spiral shape.

6. The methane engine according to claim 5, wherein the outer surfaces of the nozzle cooling channel and the combustion chamber cooling channel are coated with a cooling channel cover for protecting the nozzle cooling channel and the combustion chamber cooling channel.

7. The methane engine according to claim 1, wherein the nozzle cooling channel and the combustion chamber cooling channel are obtained by forming grooves in the outer surfaces of the nozzle and the combustion chamber and coating the outer surfaces of the nozzle and the combustion chamber with a cooling channel cover, so that the methane can be transferred through the nozzle cooling channel and the combustion chamber cooling channel.

8. The methane engine according to claim 1, wherein a nozzle inlet control valve is installed in the nozzle supply pipe at the inlet of the nozzle cooling channel and a nozzle outlet control valve is installed in the nozzle transfer pipe at the outlet of the nozzle cooling channel, and a control unit controls the nozzle inlet and outlet control valves in an interlocked state to effectively regulate the flow rate and the pressure of the methane transferred through the nozzle cooling channel so that the design of the nozzle of the combustor can be easily changed.

9. The methane engine according to claim 1, wherein a combustion chamber inlet control valve is installed in the combustion chamber supply pipe at the inlet of the combustion chamber cooling channel and a combustion chamber outlet control valve is installed in the combustion chamber transfer pipe at the outlet of the combustion chamber cooling channel, and a control unit controls the combustion chamber inlet and outlet control valves in an interlocked state to effectively regulate the flow rate and the pressure of the methane transferred through the combustion chamber cooling channel so that the design of the combustion chamber of the combustor can be easily changed.

10. The methane engine according to claim 1, wherein a methane gas supply pipe is branched off from the combustion chamber transfer pipe, and methane in a gas state, the energy of which increases by absorbing enthalpy from the combustion chamber, is supplied to a mixing head of the gas generator through the methane gas supply pipe.

11. The methane engine according to claim 10, wherein a check valve for preventing the backward flow of the methane gas is installed in the methane gas supply pipe.

12. The methane engine according to claim 10, wherein a plurality of control valves for regulating the pressure and the flow rate of the methane gas before the methane gas is supplied to the mixing head of the gas generator are installed in the methane gas supply pipe.

13. The methane engine according to claim 1, wherein a check valve for preventing the backward flow of the oxidizer and a plurality of control valves for regulating the pressure and the flow rate of the oxidizer supplied to a mixing head of the gas generator are installed in the oxidizer branch supply pipe.

14. The methane engine according to claim 4, wherein the nozzle cooling channel and the combustion chamber cooling channel are obtained by winding a pipe having a circular, oval, or polygonal section on the outer surfaces of the nozzle and the combustion chamber in a spiral shape.

15. The methane engine according to claim 14, wherein the outer surfaces of the nozzle cooling channel and the combustion chamber cooling channel are coated with a cooling channel cover for protecting the nozzle cooling channel and the combustion chamber cooling channel.

16. The methane engine according to claim 4, wherein the nozzle cooling channel and the combustion chamber cooling channel are obtained by forming grooves in the outer surfaces of the nozzle and the combustion chamber and coating the outer surfaces of the nozzle and the combustion chamber with a cooling channel cover, so that the methane can be transferred through the nozzle cooling channel and the combustion chamber cooling channel.

17. The methane engine according to claim 4, wherein a nozzle inlet control valve is installed in the nozzle supply pipe at the inlet of the nozzle cooling channel and a nozzle outlet control valve is installed in the nozzle transfer pipe at the outlet of the nozzle cooling channel, and a control unit controls the nozzle inlet and outlet control valves in an interlocked state to effectively regulate the flow rate and the pressure of the methane transferred through the nozzle cooling channel so that the design of the nozzle of the combustor can be easily changed.

18. The methane engine according to claim 4, wherein a combustion chamber inlet control valve is installed in the combustion chamber supply pipe at the inlet of the combustion chamber cooling channel and a combustion chamber outlet control valve is installed in the combustion chamber transfer pipe at the outlet of the combustion chamber cooling channel, and a control unit controls the combustion chamber inlet and outlet control valves in an interlocked state to effectively regulate the flow rate and the pressure of the methane transferred through the combustion chamber cooling channel so that the design of the combustion chamber of the combustor can be easily changed.

19. The methane engine according to claim 4, wherein a methane gas supply pipe is branched off from the combustion chamber transfer pipe, and methane in a gas state, the energy of which increases by absorbing enthalpy from the combustion chamber, is supplied to a mixing head of the gas generator through the methane gas supply pipe.

20. The methane engine according to claim 19, wherein a check valve for preventing the backward flow of the methane gas is installed in the methane gas supply pipe.

21. The methane engine according to claim 19, wherein a plurality of control valves for regulating the pressure and the flow rate of the methane gas before the methane gas is supplied to the mixing head of the gas generator are installed in the methane gas supply pipe.
